(19) United States
(12) Patent Application Publication
(10) Pub. No.: US 2008/0140546 A1
(43) Pub. Date: Jun. 12, 2008

(54) DEVICES, SYSTEMS, AND/OR METHODS FOR PRODUCING AN ELECTRIC MOTOR TERMINATION BOX

(76) Inventors: Bill Finley, Harrison, OH (US); Michael Laubenthal, Wirfus (DE); David Beckman, Loveland, OH (US); Kevin Dause, Cincinnati, OH (US); Benjamin Flick, Cincinnati, OH (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/851,716

(22) Filed: Sep. 7, 2007

Related U.S. Application Data
(60) Provisional application No. 60/842,810, filed on Sep. 7, 2006.

(51) Int. Cl. G06F 17/30; G06F 3/048; G06F 17/50

(52) U.S. Cl. 705/29; 715/771; 715/772

(57) ABSTRACT

Certain exemplary embodiments can comprise a method, which can comprise, responsive to and/or based upon a plurality of user inputs obtained via an automatically generated graphical user interface, automatically rendering a specification of a terminal box adapted for use with each of a plurality of electric motors. The plurality of electric motors can be of different frame sizes.

### CROSS-REFERENCES TO RELATED APPLICATIONS

This application claims priority to, and incorporates by reference herein in its entirety, pending U.S. Provisional Patent Application Ser. No. 60/842,810 (Attorney Docket No. 2006P18619US), filed 7 Sep. 2007.

### BACKGROUND

An electric motor can be coupled to a source of electrical energy via a terminal box. The terminal box can have a variety of designs and/or arrangements. New and unique arrangements and/or configurations of terminal boxes can be designed for certain electric motors. Manual design of terminal boxes for electric motors, such as induction motors, can be relatively costly.

### SUMMARY

Certain exemplary embodiments can comprise a method, which can comprise, responsive to and/or based upon a plurality of user inputs obtained via an automatically generated graphical user interface, automatically rendering a specification of a terminal box adapted for use with each of a plurality of electric motors. The plurality of electric motors can be of different frame sizes.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a back view of an exemplary embodiment of a terminal box system 2000;

FIG. 3 is a side view of an exemplary embodiment of a terminal box system 3000;

FIG. 4 is a perspective view of an exemplary embodiment of a terminal box system 4000;

FIG. 5 is a flowchart of an exemplary embodiment of a method 5000;

FIG. 6 is a block diagram of an exemplary embodiment of an information device 6000; and

FIG. 7 is an exemplary graphical user interface 7000.

### DETAILED DESCRIPTION

Certain exemplary embodiments can provide a method, which can comprise, responsive to and/or based upon a plurality of user inputs obtained via an automatically generated graphical user interface, automatically rendering a specification of a terminal box adapted for use with each of a plurality of electric motors. The plurality of electric motors can be of different frame sizes.

In certain exemplary embodiments, instead of manually designing a new terminal box for each motor design and/or configuration, a standardized terminal box can be configured for use with a plurality of electric motors and can be automatically designed and/or configured with a plurality of components adapted to be operatively housed therein. The terminal box can be relatively robust and/or can be utilized for electric motors of a plurality of different sizes. The terminal box can be adapted to house many motor accessories and/or can be designed and/or constructed utilizing configuration software adapted to automatically produce a bill of material for the terminal box.

The terminal box can comprise one or more of the following features:
a NEMA Type II enclosure, which can be rated for use with electrical energy of up to 6600 volts;
a blowout panel, which can be copper;
a removable back plate with different dimensions;
interchangeable feet and lifting hooks;
capacity for lightning arresters;
capacity for surge capacitors;
capacity for space heater;
capacity for one or more current transformers and/or metering current transformers;
a removable neutral link;
a removable bottom plate;
meets one or more American Petroleum Institute (API) specifications; and/or
breather drain; etc.

In certain exemplary embodiments, via a symmetrical design and/or interchangeability of the back plate, lifting hooks, and/or feet, a given box can be used for different configurations of various electric motor frame types. By changing locations of feet and/or lifting hooks, certain terminal boxes can provide for top and/or bottom entry of electrical wires, such as electrical cables. In certain exemplary embodiments, by rotating and/or flipping the back plate, an aperture location on a back of the terminal box can be changed so the box can be used for different motors.

Certain exemplary embodiments can comprise design and/or fabrication of a universal terminal box adapted for use with a plurality of electric motors between approximately 500 horsepower and approximately 10,000 horsepower. The terminal box can be a NEMA/ANSI type II terminal box. In certain exemplary embodiments, the enclosure of the terminal box can be a NEMA 4 enclosure. The terminal box can comprise a plurality of non-destructively releasably attached lifting hooks, which can be non-destructively releasably attached at a plurality of locations on the terminal box. The terminal box can comprise a plurality of substantially non-destructively releasably attached feet, which can be substantially non-destructively releasably attached at a plurality of locations on the terminal box. The terminal box can comprise a removable back plate, which defines an opening that can be adapted to receive electrical wires. The electrical wires can electrically couple the electric motor to an electrical energy source. A back plate of the terminal box can be adapted to be flippably and/or rotatably attached to the terminal box such that the opening can be positioned in at least four locations relative to a front panel center location of the terminal box. In certain exemplary embodiments, a removable plate can be adapted to allow the terminal box to receive the electrical wires from either above or below the terminal box. Components housed by the terminal box can be located in specific and/or predetermined locations within the terminal box.

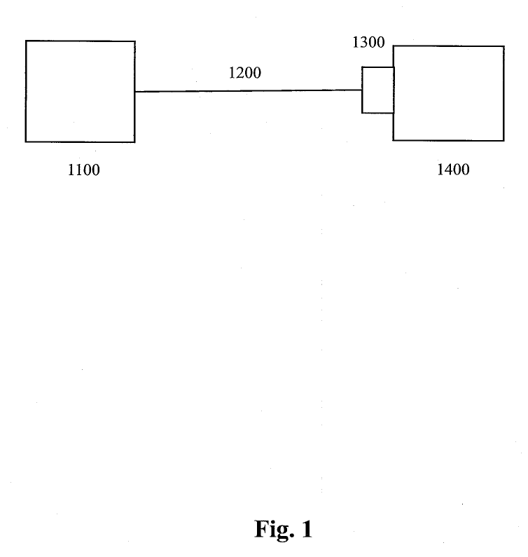

FIG. 1 is a block diagram of an exemplary embodiment of a system 1000, which can comprise an electrical energy source 1100 and an electric motor 1400. Electrical energy source 1100 can be electrically coupled to electric motor 1400 via a plurality of electrical wires 1200 and a terminal box 1300.

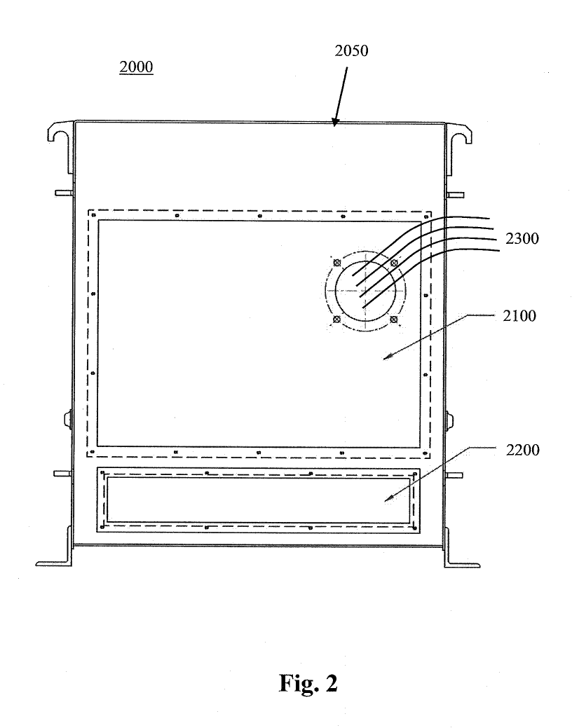

FIG. 2 is a back view of an exemplary embodiment of a terminal box system 2000, which can comprise a terminal box 2050, a back plate 2100, and a blowout panel 2200. Terminal box system 2000 can be adapted to be substantially non-destructively releasably and/or operatively attached to a selected electric motor of a plurality of electric motors. Terminal box 2050 can be adapted to receive a plurality of electrical wires 2300, which can be adapted to convey electrical energy to the selected electric motor. The plurality of electric motors can have a power output of a range between approximately 500 horsepower and approximately 10,000 horsepower. When operatively coupled to any of the plurality of electric motors, terminal box 2050 can be adapted to house components operatively coupled to, and/or sized for, each of the plurality of electric motors. Blowout panel 2200 can be adapted to release an excess of electrical energy from terminal box 2050. Terminal box 2050 can be compliant with one or more American Petroleum Institute standards for electric motor terminal boxes. Terminal box 2050 can be a NEMA/ANSI type II terminal box.

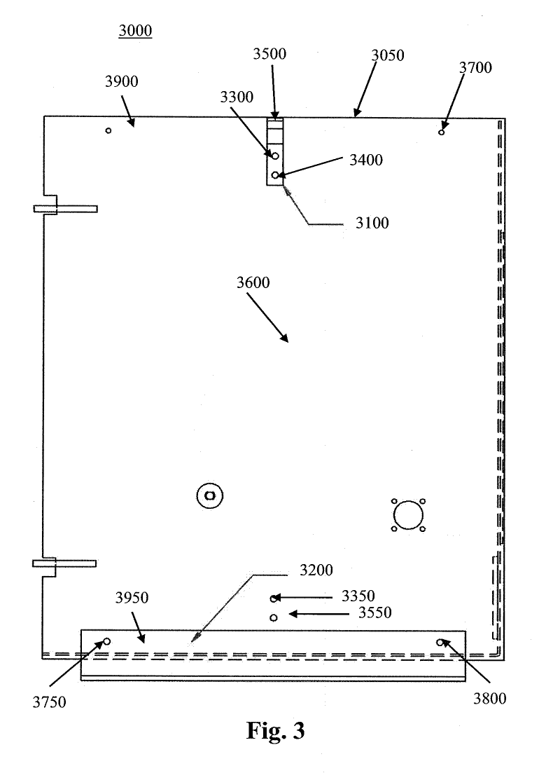

FIG. 3 is a side view of an exemplary embodiment of a terminal box system 3000, which can comprise a terminal box 3050, a first lifting hook 3100, and a first foot 3200. An opposing side of the terminal box to that illustrated in FIG. 3 can comprise a substantially non-destructively releasably attached second foot of a pair of feet and a substantially non-destructively releasably attached second lifting hook of a pair of lifting hooks.

The pair of lifting hooks can be adapted to be non-destructively releasably attached to terminal box 3050. Terminal box 3050 can define a first set of hook openings 3300 and a second set of hook openings 3350. First set of hook openings 3300 can be adapted to receive fasteners 3400, which can be adapted to substantially non-destructively mount the pair of lifting hooks to first pair of lifting hook mounting sites 3500. Second set of hook openings 3350 can be adapted to receive fasteners 3400, which can be adapted to substantially non-destructively mount the pair of lifting hooks to a second pair of lifting hook mounting sites 3550. Each of first pair of lifting hook mounting sites 3500 can be at an opposing end region of a surface 3600 compared to a corresponding mounting site of second pair of lifting hook mounting sites 3550.

The pair of feet adapted to be substantially non-destructively releasably attached to terminal box 3050. Terminal box 3050 can define a first set of foot openings 3700 and a second set of openings 3750. First set of openings 3700 can be adapted to receive fasteners 3800, which can be adapted to substantially non-destructively mount the pair of feet to a first pair of foot mounting sites 3900. Second set of openings 3750 can be adapted to receive fasteners 3800, which can be adapted to substantially non-destructively mount the pair of feet to a second pair of foot mounting sites 3960. Each of first pair of foot mounting sites 3900 can be at an opposing end region of surface 3600 compared to a corresponding mounting site of second pair of foot mounting sites 3950.

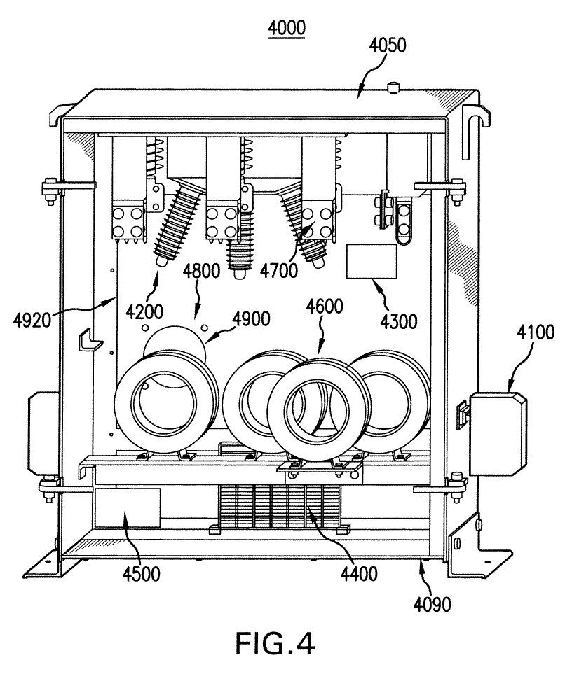

FIG. 4 is a perspective view of an exemplary embodiment of a terminal box system 4000, which can comprise a terminal box 4050 and/or an auxiliary box 4100. Terminal box 4050 can be adapted to operatively house a plurality of components. The plurality of components can comprise at least one lightening arrestor 4200, surge capacitor 4300, bus bar 4400, space heater 4500, current transformer 4600, and/or set of terminals 4700. Terminal box 4050 can comprise a substantially non-destructively releasably attachable back plate 4800. Releasably attachable back plate 4800 can define a conductor opening 4900 adapted to substantially non-destructively receive a plurality of electrical wires. Responsive to a flip or a rotation of back plate 4800, conductor opening 4900 can be adapted to be operatively positioned in any of four quadrants of a back plate opening 4920 defined by terminal box 4050 and substantially covered by back plate 4800. Lightning arrestor 4200, surge capacitor 4300, bus bar 4400, and/or space heater 4500 can be adapted to be substantially housed within terminal box 4050. Bus bar 4400 can be a silver plated bus bar.

Auxiliary box 4100 can be adapted to be operatively coupled to terminal box 4050 and can be used to couple an electric motor operatively thereto. Terminal box 4050 can comprise and/or define a breather drain 4090, which can be adapted to drain moisture that enters and/or is condensed within terminal box 4050.

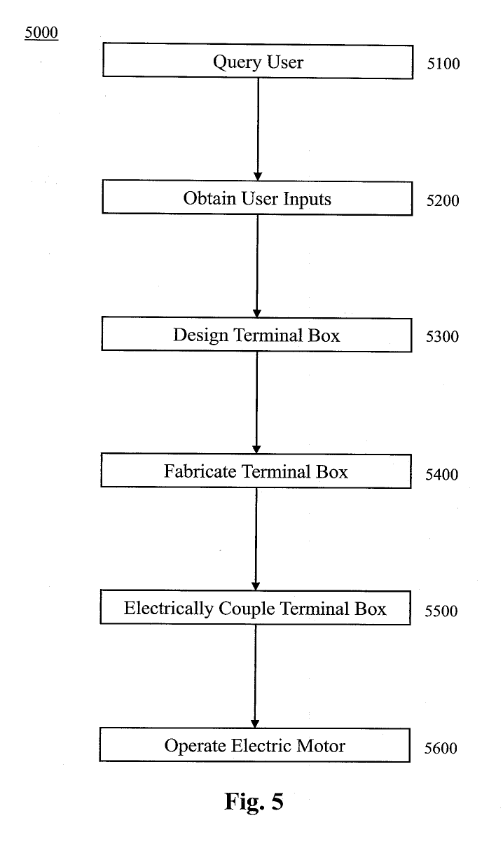

FIG. 5 is a flowchart of an exemplary embodiment of a method 5000. Any activity or combination of activities in method 5000 can be implemented automatically. Any activity or combination of activities in method 5000 can be implemented via machine instructions stored on a machine-readable medium. At activity 5100, a user can be queried regarding specifications for a terminal box. The user can be queried manually by an engineering entity and/or automatically via an information device via a graphical user interface.

At activity 5200, inputs can be obtained from the user regarding desires and/or specifications for the terminal box. These inputs can be manually and/or automatically transferred to a design entity, which can be adapted to provide the terminal box and/or components therein responsive to the specifications for the terminal box. The user inputs can comprise a frame size, an enclosure type, a voltage rating, a count of the electrical wires, an electric wiring connection type of the terminal box, a stator grounding requirement, and/or an entry position of electrical wiring coupling the electrical motor to an energy source, etc.

At activity 5300, the terminal box can be automatically designed and/or a bill of materials can be automatically rendered responsive to the user inputs obtained via an automatically generated graphical user interface. The bill of materials can be for the terminal box and/or components adapted to be comprised therein. The bill of materials can comprise a blowout panel, a back plate, one or more lightning arrestors, a plurality of current transformers, a terminal box space heater, a surge capacitor, one or more bus bars, an auxiliary box, and/or a breather drain, etc. The specification of a terminal box adapted for use with each of a plurality of electric motors can be automatically rendered. The plurality of electric motors can be of different frame sizes. The terminal box can comprise a National Electrical Manufacturer's Association (NEMA) 4 enclosure. The terminal box can comprise a flippable and/or rotatable back plate, which can be configured to provide four distinct locations, relative to a center of the terminal box, of a defined port adapted to receive electrical wires. The graphical user interface can be adapted to query a user regarding a plurality of components adapted to be operatively coupled to the terminal box. The plurality of components can comprise a lightning arrestor, a plurality of current transformers, and/or a terminal box space heater.

At activity 5400, the terminal box can be fabricated according to the automatic design and/or utilizing materials obtained based upon an automatically generated bill of materials. The terminal box can be adapted to be substantially non-destructively releasably and/or operatively attached to a selected electric motor of a plurality of electric motors. The terminal box can be adapted to receive a plurality of electrical wires. The plurality of electrical wires can be adapted to convey electrical energy to the selected electric motor. The plurality of electric motors can have a power output of a range between approximately 500 horsepower and approximately 10,000 horsepower. When operatively coupled to any of the plurality of electric motors, the terminal box can be adapted to house components operatively coupled to, and/or sized for, each of the plurality of electric motors. The components can comprise at least one lightening arrestor, surge capacitor, bus bar, space heater, current transformer, and/or set of terminals, etc. The terminal box can comprise a substantially non-destructively releasably attachable back plate, which can define a conductor opening adapted to receive the plurality of electrical wires. Responsive to a flip or a rotation of the back plate, the conductor opening can be adapted to be operatively positioned in any of four quadrants of a back plate opening defined by the terminal box and substantially covered by the back plate.

At activity 5500, via the terminal box, an associated electric motor can be electrically coupled to an electrical energy source. The electric motor can be operatively coupled to a load, such as a pump adapted to transfer a petroleum product.

At activity 5600, the electric motor can be operated. Electrical energy can flow through a plurality of electric wires from the electrical energy source to the electric motor. The electric motor can be adapted to perform useful work such as the transfer of the petroleum product from a first location to a second location.

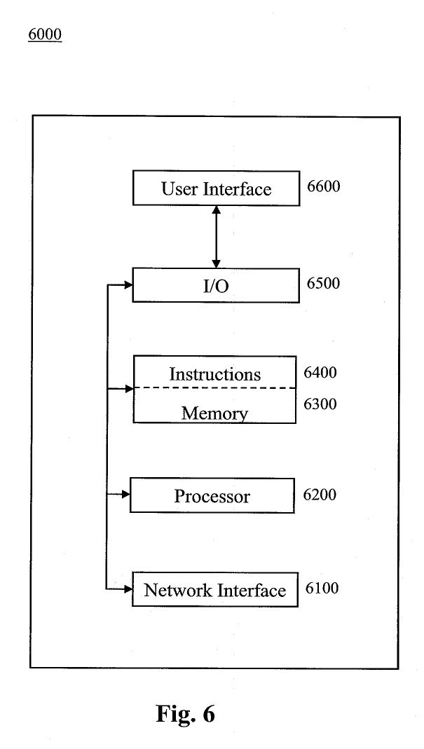

FIG. 6 is a block diagram of an exemplary embodiment of an information device 6000, which can comprise any of numerous components, such as for example, one or more network interfaces 6100, one or more processors 6200, one or more memories 6300 containing instructions 6400, one or more input/output (I/O) devices 6500, and/or one or more user interfaces 6600 coupled to I/O device 6500, etc.

In certain exemplary embodiments, via one or more user interfaces 6600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, and/or information described herein, such as a rendering of information related to specifying, designing, and/or constructing a terminal box and/or components thereof.

Information device 6000 can be adapted to, responsive to and/or based upon a plurality of user inputs obtained via an automatically generated graphical user interface, automatically render a bill of materials of a terminal box system that comprises a terminal box. The terminal box system can be adapted to be operatively coupled to each of a plurality of electric motors. The plurality of electric motors can be of different frame sizes. The terminal box can comprise a National Electrical Manufacturer's Association (NEMA) 4 enclosure. The terminal box can comprise a flippable and/or rotatable back plate. The flippable and/or rotatable back plate can be configured to provide four distinct locations, relative to a center of the terminal box, for a defined port adapted to receive electrical wires. The information device can be adapted to automatically generate the graphical user interface. The graphical user interface can be adapted to query a user regarding the plurality of user inputs. The plurality of user inputs can comprise a frame size, an enclosure type, a voltage rating, and/or a count of motor leads, etc.

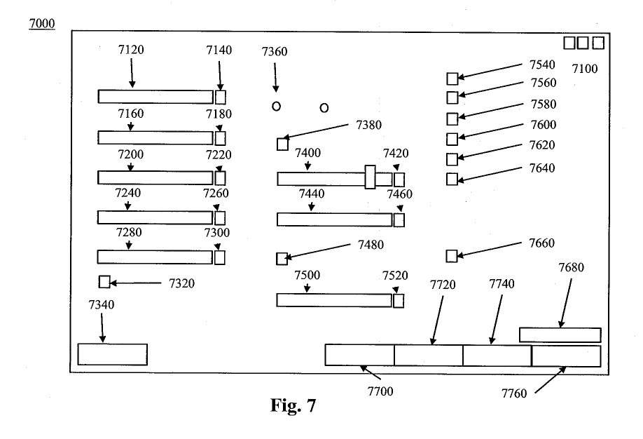

FIG. 7 is an illustration of an exemplary graphical user interface 7000, which can comprise a set of elements, fields, and/or input tools. Graphical user interface 7000 can be adapted to query a user regarding an electric motor and/or a terminal box associated with the electric motor.

In certain exemplary embodiments, the elements of graphical user interface 7000 can be as follows:
set of elements 7100 can be used to resize and/or close graphical user interface 7000;
element 7120 can receive an electric motor frame size via a selection made using scroll button 7140;
element 7160 can receive an electric motor enclosure type via a selection made using scroll button 7180;
element 7200 can receive a nominal electric motor voltage via a selection made using scroll button 7220;
element 7240 can receive a count of motor leads and/or electrical wires associated with the electric motor via a selection made using scroll button 7260;
element 7280 can receive an electric motor connection type via a selection made using scroll button 7300;
element 7320 can be adapted to receive a specification of a stator ground;
element 7340 can be a button that is pressed to cause an automatic generation of a bill of materials associated with a terminal box;
via selection of one of buttons 7360, the user can specify a location of entry for the electrical wires and/or motor leads;
via element 7380, the user can specify that a plurality of current transformers will be provided with the terminal box;
element 7400 can receive a protection type of the current transformers via a selection made using scroll button 7420;
element 7440 can receive a relay accuracy ratio of the current transformers via a selection made using scroll button 7460;
element 7480 can be used to specify a metering current transformer;
element 7500 can receive a relay accuracy ratio of the metering current transformer via a selection made using scroll button 7520;
element 7540 can be used to specify a lightning arrestor;
element 7560 can be used to specify a surge capacitor;
element 7580 can be used to specify a silver plated bus bars;
element 7600 can be used to specify a stainless steel auxiliary box;
element 7620 can be used to specify a terminal box space heater;
element 7640 can be used to specify a breather drain;
element 7660 can be used to specify compliance with API standards;
element 7680 can be used to specify a name under which the terminal box specification and/or bill of materials can be saved;
element 7700 can be used to reset default settings on graphical user interface 7000;
element 7720 can be used to cause the graphical user interface to obtain a specification for the terminal box;
element 7740 can be used to save the user inputs obtained via graphical user interface 7000; and/or
element 7760 can be used to close graphical user interface 7000; etc.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, deed, function, step, and/or process and/or a portion thereof.
according—agreeing with.
adapted—suitable, fit, and/or capable of performing a specified function.
adapted to—suitable, fit, and/or capable of performing a specified function.
adjacent—in close proximity to, near, next to, and/or adjoining.
and/or—either in conjunction with or in alternative to.
any—an unspecified selected one from a set.
apparatus—an appliance or device for a particular purpose.
approximately—about and/or nearly the same as.
associated with—related to.
at least—not less than.
attach—to fasten, secure, couple, and/or join.
automatically—acting and/or operating in a manner essentially independent of external human influence and/or control. For example, an automatic light switch can turn on upon “seeing” a person in its view, without the person manually operating the light switch.
auxiliary box—a housing adapted to enclose components related to those comprised within a terminal box.
back plate—a substantially planar substantially non-destructively releasably attachable portion of a terminal box that is adapted to cover at least a portion of an otherwise substantially open rear portion of the terminal box.
based upon—determined in consideration of and/or derived from.
between—in a separating interval and/or intermediate to.
bill of materials—a list of components.
blowout panel—a plate adapted to release excess electrical energy from a terminal box.
breather drain—an aperture adapted to drain moisture from a housing.
bus—an electrical conductor that makes a common connection between a plurality of circuits.
bus bar—a common electrical power terminal to which multiple circuits are electrically coupled through fuses and/or circuit breakers.
can—is capable of, in at least some embodiments.
cause—to bring about, provoke, precipitate, produce, elicit, be the reason for, result in, and/or effect.
center—a point that is substantially equally distant from the outer boundaries of something.
circuit—an electrically conductive pathway and/or a communications connection established across two or more switching devices comprised by a network and between corresponding end systems connected to, but not comprised by the network.
compare—to examine in order to note similarities and/or differences in relation to something else.
component—a constituent element and/or part.
comprised by—included by.
comprise—to include but not be limited to.
conductor—a component of a circuit breaker adapted to conduct a large majority of electrical current carried by the circuit breaker.
configure—to design, arrange, set up, shape, and/or make suitable and/or fit for a specific purpose.
configured to—capable of performing a particular function.
connection—a physical and/or logical link and/or channel between two or more points in a system. For example, a wire, an optical fiber, a wireless link, and/or a virtual circuit, etc.
convey—to transmit, transport, guide, and/or carry.
corresponding—related, associated, accompanying, similar in purpose and/or position, conforming in every respect, and/or equivalent and/or agreeing in amount, quantity, magnitude, quality, and/or degree.
count—(n) a number reached by counting and/or a defined quantity. (v.) to increment, typically by one and beginning at zero.
couple(d)—to join, connect, and/or link two things together.
cover—(n) a substantially planar object configured to protect and/or conceal; (v) to overlay, place upon and/or over.
current transformer—a device electrically and/or magnetically couplable to an electric circuit, the device adapted to output a secondary electrical current in response to the electrical current (the “primary current”) in the electric circuit, the secondary current typically a predetermined ratio of the primary current.
define—to establish the meaning, relationship, outline, form, and/or structure of; and/or to precisely and/or distinctly describe and/or specify.
design—(n) a purposeful arrangement of parts and/or details. For example, the design of a product and/or process can comprise designing predetermined aspects of the product and/or process. (v) to plan, such as in a manner that comprises the development of a graphic representation.
determine—to obtain, calculate, decide, deduce, establish, and/or ascertain.
device—a machine, manufacture, and/or collection thereof.
different—changed, distinct, and/or separate.
distinct—discrete and/or readily distinguishable from all others.
each—every one of a group considered individually.
electrical energy—energy characterized by the flow of electric charge through a conductor.
electric motor—a motion-imparting device powered by electricity.
electrical wires—insulated strands of an electrically conductive metal.
enclosure—a housing adapted to comprise and/or shelter electrical components.
end region—a portion that is in a vicinity of an extreme edge of an object surface.
energy—usable power.
entry position—a relative location at which something penetrates an object.
fastener—a restraint that attaches to something and/or holds something in place. A fastener can be a screw, bolt, hook and/or loop of a hook and loop fastener system, button, hook, catch, snap, latch, buckle, loop, tie, clamp, connector, coupler, link, band, zipper, releasable adhesive, plug and socket, and/or any other releasable mechanism for attachment, and/or a glue, bond, weld, and/or any other permanent mechanism for attachment.
feet—components at and/or near an extreme edge of an object that are adapted to rest on a surface and provide support for weight of the object.
first—an initial entity in an ordering.
flip—to turn over.
for—with a purpose of.
frame—a supporting structure for parts of an AC motor.
frame size—a standardized set of motor dimensions that include bolt hole size, mounting base dimensions, shaft height, shaft diameter, and shaft length.
from—used to indicate a source.
further—in addition.
generate—to create, produce, render, give rise to, and/or bring into existence.
graphical user interface—an interface between a human and a communication device that takes advantage of the device's graphics capabilities to make the program easier to use. Well-designed graphical user interfaces can free the user from learning complex command languages.
greater—larger and/or more than.
ground—to electrically couple to a common return path for electrical current.
group—a plurality of determined units.
have—to be identified by.
height—a measurement of the extent of something along a dimension.
hook—a curved or angular protrusion adapted to catch, pull, hold, and/or suspend something.
horsepower—a unit of rate of doing work that equals approximately 746 watts.
inch—a unit of linear measurement in the English system equal to approximately 2.54 cm.
information device—any device on which resides a finite state machine capable of implementing at least a portion of a method, structure, and/or or graphical user interface described herein. An information device can comprise well-known communicatively coupled components, such as one or more network interfaces, one or more processors, one or more memories containing instructions, one or more input/output (I/O) devices, and/or one or more user interfaces (e.g., coupled to an I/O device) via which information can be rendered to implement one or more functions described herein. For example, an information device can be any general purpose and/or special purpose computer, such as a personal computer, video game system (e.g., PlayStation, Nintendo Gameboy, X-Box, etc.), workstation, server, minicomputer, mainframe, supercomputer, computer terminal, laptop, wearable computer, and/or Personal Digital Assistant (PDA), iPod, mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, a digital signal processor, an ASIC or other integrated circuit, a hardware electronic logic circuit such as a discrete element circuit, and/or a programmable logic device such as a PLD, PLA, FPGA, or PAL, or the like, etc.
input—a signal, data, and/or information provided to a processor, device, and/or system.
length—a longest dimension of something and/or the measurement of the extent of something along its greatest dimension.
less than—having a measurably smaller magnitude and/or degree as compared to something else.
lifting hook—a device and/or system adapted to receive a motive force to vertically raise the hook and/or an object coupled thereto.
lightning arrestor—a device and/or system adapted to shunt and/or divert electrical energy of a lighting strike to an earthed ground.
location—a place.
machine instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable—capable of being discerned by an information device.
machine-readable medium—a physical structure from which a machine, such as an information device, computer, microprocessor, and/or controller, etc., can obtain and/or store data, information, and/or instructions. Examples include memories, punch cards, and/or optically-readable forms, etc.
manufacturing entity—a person, team, role, organization, computer, and/or application that constructs something.
may—is allowed and/or permitted to, in at least some embodiments.
method—a process, procedure, and/or collection of related activities for accomplishing something.
more—in greater quantity.
mount—(n) that upon which a thing is attached. (v) to couple, fix, and/or attach on and/or to something.
National Electrical Manufacturers Association (NEMA)—a trade association that establishes standards used in electrical products.
NEMA 4 Enclosure—fabricated in accordance with the current NEMA 4 enclosure specification in NEMA Standards Publication No. 250.
NEMA/ANSI type II—fabricated in accordance with the current type II specification in NEMA Standards Publication No. 250.
non-destructively—of, relating to, or being a process that does not result in damage to the subject material and/or product and/or results in such minimal damage that the subject material and/or product can be re-used for its intended purpose.
obtain—to receive, get, take possession of, procure, acquire, calculate, determine, and/or compute.
one—a single unit.
opening—an aperture.
operative—being in effect; operating.
opposing—opposite; against; being the other of two complementary or mutually exclusive things; placed or located opposite, in contrast, in counterbalance, and/or across from something else and/or from each other.
outside—the space beyond a boundary and/or limit.
pair—a quantity of two of something.
plurality—the state of being plural and/or more than one.
port—an opening for the insertion and/or passage of a part and/or fluid.
portion—a part, component, section, percentage, ratio, and/or quantity that is less than a larger whole. Can be visually, physically, and/or virtually distinguishable and/or non-distinguishable.
power output—provided electric power.
processor—a hardware, firmware, and/or software machine and/or virtual machine comprising a set of machine-readable instructions adaptable to perform a specific task. A processor can utilize mechanical, pneumatic, hydraulic, electrical, magnetic, optical, informational, chemical, and/or biological principles, mechanisms, signals, and/or inputs to perform the task(s). In certain embodiments, a processor can act upon information by manipulating, analyzing, modifying, and/or converting it, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
produce—to generate via a physical effort.
predetermined—established in advance.
predict—prognosticate regarding a future event.
provide—to furnish, supply, give, convey, send, and/or make available.
quadrant—one of four parts into which a plane is divided by two substantially perpendicular lines.
query—(n) a request, such as for information from a database. (v) to request and/or obtain information, such as from a database in response to a structured request.
range—a measure of an extent of a set of values and/or an amount and/or extent of variation.
rating—a performance capability.
regarding—pertaining to.
receive—to gather, take, acquire, obtain, accept, get, and/or have bestowed upon.
regarding—pertaining to.
relative—considered with reference to and/or in comparison to something else.
relay accuracy ratio—a specified precision of a measurement obtained by a current transformer.
releasably—capable of being freed, in a substantially non-destructive manner, from something that binds, fastens, or holds back.
release—to let go and/or free from something that restrains, binds, fastens, and/or holds back.
render—to display, annunciate, speak, print, and/or otherwise make perceptible to a human, for example as data, commands, text, graphics, audio, video, animation, and/or hyperlinks, etc., such as via any visual, audio, and/or haptic mechanism, such as via a display, monitor, printer, electric paper, ocular implant, cochlear implant, speaker, etc.
require—to compel, demand, need, and/or request.
requirement—a thing demanded.
responsive—reacting to an influence and/or impetus.
rotatable—capable of rotation.
rotate—to turn around a center and/or an axis.
rotation—an act and/or process of turning around a center and/or an axis.
said—when used in a system or device claim, an article indicating a subsequent claim term that has been previously introduced.
second—an entity immediately following a first entity in an ordering.
selected—a chosen item.
set—a related plurality of predetermined elements; and/or one or more distinct items and/or entities having a specific common property or properties.
site—a physical position of something.
size—physical dimensions, proportions, magnitude, amount, and/or extent of an entity.
source—a point at which something originates, springs into being, and/or from which it derives and/or is obtained.
space heater—a device adapted to warm a defined volume of air.
specify—to describe, characterize, indicate, and/or state explicitly and/or in detail.
specification—a description or characterization.
stator—a stationary part in or about which another part (the rotor) revolves.
substantially—to a considerable, large, and/or great, but not necessarily whole and/or entire, extent and/or degree.
surface—the outer boundary of an object or a material layer constituting or resembling such a boundary.
surge capacitor—a device adapted to absorb surges of electrical energy and/or reduce a steepness of an electrical energy wave front.
system—a collection of mechanisms, devices, data, and/or instructions, the collection designed to perform one or more specific functions.
terminal box—a housing adapted to contain a plurality of components adapted to electrically couple an electric motor to an electrical energy source.
type—a number of things having in common traits or characteristics that distinguish them as a group or class.
use—to put into service.
user—a person, organization, process, device, program, protocol, and/or system that uses a device, system, process, and/or service.
user interface—a device and/or software program for rendering information to a user and/or requesting information from the user. A user interface can include at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
utilize—to use and/or put into service.
via—by way of and/or utilizing.
voltage—(a.k.a., “potential difference” and “electro-motive force” (EMF)) a difference in electrical potential between any two conductors of an electrical circuit and/or a quantity, expressed as a signed number of Volts (V), and measured as a signed difference between two points in an electrical circuit which, when divided by the resistance in Ohms between those points, gives the current flowing between those points in Amperes, according to Ohm's Law.
when—at a time.
wherein—in regard to which; and; and/or in addition to.
width—a measurement of the extent of something along a dimension.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, abstract, drawing figure, etc.) of this application, unless clearly specified to the contrary, such as via an explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
any elements can be integrated, segregated, and/or duplicated;
any activity can be repeated, performed by multiple entities, and/or performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Any information in any material (e.g., a U.S. patent, U.S. patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

Accordingly, every portion (e.g., title, field, background, summary, abstract, drawing figure, etc.) of this application, other than the claims themselves, is to be regarded as illustrative in nature, and not as restrictive.

What is claimed is:

1. A method comprising:
responsive to and based upon a plurality of user inputs obtained via an automatically generated graphical user interface, automatically rendering a specification of a terminal box adapted for use with each of a plurality of electric motors, said plurality of electric motors of different frame sizes, said terminal box comprising a National Electrical Manufacturer's Association (NEMA) 4 enclosure, said terminal box comprising a flippable and rotatable back plate, said flippable and rotatable back plate configured to provide four distinct locations, relative to a center of said terminal box, of a defined port adapted to receive electrical wires, said graphical user interface adapted to query a user regarding a plurality of components adapted to be operatively coupled to said terminal box, said plurality of components comprising a lightning arrestor, a plurality of current transformers, and a terminal box space heater.

2. The method of claim 1, further comprising:
responsive to said plurality of user inputs, automatically rendering a bill of materials for said terminal box.

3. The method of claim 1, further comprising:
responsive to said plurality of user inputs, automatically rendering a bill of materials for said terminal box, said bill of materials comprising a blowout panel adapted to be operatively coupled to said terminal box.

4. The method of claim 1, further comprising:
responsive to said plurality of user inputs, automatically rendering a bill of materials for said terminal box, said bill of materials comprising said back plate.

5. The method of claim 1, further comprising:
responsive to said plurality of user inputs, automatically rendering a bill of materials for said plurality of components.

6. The method of claim 1, further comprising:
responsive to said plurality of user inputs, automatically rendering a bill of materials for said plurality of components, said plurality of components comprising said lightning arrestor, said plurality of current transformers, and said terminal box space heater.

7. The method of claim 1, further comprising:
responsive to said plurality of user inputs, automatically rendering a bill of materials for said plurality of components, said plurality of components comprising a surge capacitor, a bus bar, and a breather drain.

8. The method of claim 1, further comprising:
responsive to said plurality of user inputs, automatically rendering a bill of materials for said plurality of components, said plurality of components comprising a plurality of bus bars and an auxiliary box.

9. The method of claim 1, further comprising:
via said graphical user interface, querying said user for said plurality of user inputs, said user inputs regarding an electric motor of said plurality of electric motors, said user inputs comprising a frame size, an enclosure type, a voltage rating, and a count of said electrical wires.

10. The method of claim 1, further comprising:
via said graphical user interface, querying said user for said plurality of user inputs, said user inputs regarding an electric motor of said plurality of electric motors, said user inputs comprising an electric wiring connection type of said terminal box, a stator grounding requirement, and an entry position of electrical wiring coupling said electrical motor to an energy source.

11. The method of claim 1, wherein said terminal box is a NEMA/ANSI type II terminal box.

12. The method of claim 1, wherein said plurality of components further comprise a surge capacitor and a bus bar.

13. The method of claim 1, wherein said plurality of components further comprise an auxiliary box and a breather drain.

14. The method of claim 1, wherein said graphical user interface is adapted to query a user regarding a type of said plurality of current transformers.

15. The method of claim 1, wherein said graphical user interface is adapted to query a user regarding a relay accuracy ratio of said plurality of current transformers.

16. A system comprising:
an information device adapted to, responsive to and based upon a plurality of user inputs obtained via an automatically generated graphical user interface, automatically render a bill of materials of a terminal box system that comprises a terminal box, said terminal box system adapted to be operatively coupled to each of a plurality of electric motors, said plurality of electric motors of different frame sizes, said terminal box comprising a National Electrical Manufacturer's Association (NEMA) 4 enclosure, said terminal box comprising a flippable and rotatable back plate, said flippable and rotatable back plate configured to provide four distinct locations, relative to a center of said terminal box, of a defined port adapted to receive electrical wires, said information device adapted to automatically generate said graphical user interface, said graphical user interface adapted to query a user regarding said plurality of user inputs, said plurality of user inputs comprising a frame size, an enclosure type, a voltage rating, and a count of motor leads.

17. A machine-readable medium comprising machine instructions for activities comprising:
responsive to and based upon a plurality of user inputs obtained via an automatically generated graphical user interface, automatically rendering a bill of materials of a terminal box system that comprises a terminal box, said terminal box system adapted to be operatively coupled to each of a plurality of electric motors, said plurality of electric motors of different frame sizes, said plurality of electric motors having a power output of a range between approximately 500 horsepower and approximately 10,000 horsepower, said terminal box comprising a National Electrical Manufacturer's Association (NEMA) 4 enclosure, said terminal box comprising a flippable and rotatable back plate, said flippable and rotatable back plate configured to provide four distinct locations, relative to a center of said terminal box, of a defined port adapted to receive electrical wires, said graphical user interface adapted to query a user regarding said plurality of user inputs, said plurality of user inputs comprising a frame size, an enclosure type, a voltage rating, and a count of motor leads.

18. A system comprising:
a circuit adapted to, responsive to and based upon a plurality of user inputs obtained via an automatically generated graphical user interface, automatically render a bill of materials of a terminal box system that comprises a terminal box, said terminal box system adapted to be operatively coupled to each of a plurality of electric motors, said plurality of electric motors of different frame sizes, said terminal box comprising a National Electrical Manufacturer's Association (NEMA) 4 enclosure, said terminal box comprising a blowout panel, said blowout panel adapted to release energy from said terminal box, said circuit adapted to automatically generate a graphical user interface, said graphical user interface adapted to query a user regarding said plurality of user inputs, said plurality of user inputs comprising a frame size, an enclosure type, a voltage rating, and a count of motor leads.

19. A method comprising:
responsive to and based upon a plurality of user inputs obtained via an automatically generated graphical user interface, automatically generating a bill of materials of a terminal box system that comprises a terminal box, said terminal box adapted to be substantially non-destructively releasably and operatively attached to a selected electric motor of a plurality of electric motors, said terminal box adapted to receive a plurality of electrical wires, said plurality of electrical wires adapted to convey electrical energy to said selected electric motor, said plurality of electric motors having a power output of a range between approximately 500 horsepower and approximately 10,000 horsepower, when operatively coupled to any of said plurality of electric motors, said bill of materials comprising components operatively coupled to, and sized for, each of said plurality of electric motors, said components comprising a lightening arrestor, a surge capacitor, bus bars, a space heater, a plurality of current transformers, and a plurality of terminals, said terminal box comprising a substantially non-destructively releasably attachable back plate, said back plate defining a conductor opening adapted to receive said plurality of electrical wires, responsive to a flip or a rotation of said back plate, said conductor opening adapted to be operatively positioned in any of four quadrants of a back plate opening defined by said terminal box and substantially covered by said back plate, said terminal box operatively attached to a pair of lifting hooks, said terminal box defining a first set of openings and a second set of openings, said first set of openings adapted to receive fasteners adapted to substantially non-destructively mount said pair of lifting hooks to a first pair of lifting hook mounting sites, said second set of openings adapted to receive fasteners adapted to substantially non-destructively mount said pair of lifting hooks to a second pair of lifting hook mounting sites, each of said first pair of lifting hook mounting sites at an opposing end region of a surface compared to a corresponding mounting site of said second pair of lifting hook mounting sites, a pair of feet adapted to be substantially non-destructively releasably attached to said terminal box, said terminal box defining a third set of openings and a fourth set of openings, said third set of openings adapted to receive fasteners adapted to substantially non-destructively mount said pair of feet to a first pair of foot mounting sites, said fourth set of openings adapted to receive fasteners adapted to substantially non-destructively mount said pair of feet to a second pair of foot mounting sites, each of said first pair of foot mounting sites at an opposing end region of a surface compared to a corresponding mounting site of said second pair of foot mounting sites.
